(19) United States
(12) Patent Application Publication
(10) Pub. No.: US 2006/0077972 A1
(43) Pub. Date: Apr. 13, 2006

(54) Processing voice data in packet communication network with encryption

(76) Inventor: Dae-Hyun Lee, Suwon-si (KR)

Correspondence Address: Robert E. Bushnell, Suite 300, 1522 K Street, N.W., Washington, DC, 20005-1202, US

(21) Appl. No.: 11/247,946

(22) Filed: Oct. 12, 2005

(30) Foreign Application Priority Data
Oct. 12, 2004 (KR) 2004-81504

(51) Int. Cl. H04L 12/66

(52) U.S. Cl. 370/356

(57) ABSTRACT

Processing voice data in a packet communication network with encryption for efficient use of a bandwidth in a Virtual Private Network (VPN) includes: confirming, by a terminal at a transmitting side, a destination address of a call connection packet; when the destination address is directed to a private network, storing call connection information within the call connection packet and registering the call connection information with an address translation table; encrypting, by the terminal at the transmitting side, the call connection packet and transmitting the encrypted call connection packet to a receiving side; storing, by a terminal at the receiving side receiving the call connection packet, the call connection information within the call connection packet therein; encrypting, by the terminal at the receiving side, a call connection response packet responsive to the call connection packet and transmitting the encrypted response packet to the terminal at the transmitting side to establish a communication path between the terminal at the transmitting side and the terminal at the receiving side; and transmitting, by the terminal at the transmitting side and the terminal at the receiving side, non-encrypted voice media data using the call connection information via the communication path.

### CLAIM OF PRIORITY

This application makes reference to, incorporates the same herein, and claims all benefits accruing under 35 U.S.C. §119 from an application entitled METHOD AND APPARATUS FOR PROCESSING VOICE DATA IN PACKET COMMUNICATION NETWORK WITH ENCRYPTION FOR EFFICIENT USE OF BANDWIDTH earlier filed in the Korean Intellectual Property Office on Oct. 12, 2004 and thereby duly assigned Serial No. 10-2004-0081504.

### BACKGROUND OF THE INVENTION

1. Field of the Invention

The present invention relates to processing voice data in a packet communication network with encryption for efficient use of a bandwidth and, more particularly, to processing voice data using an Internet protocol in a Virtual Private Network (VPN).

2. Description of the Related Art

A technique for transferring voice information using an Internet Protocol (IP) in a packet switch network, which is being used as a data network, is called a Voice over Internet Protocol (VoIP). Unlike a Public Switched Telephone Network (PSTN) which is a traditional line-based protocol, the VoIP sends digitalized voice information over discrete packets.

Efficient sharing of limited resources is required in an IP network, which is a basis of the VoIP. Inefficient sharing may lead to a data loss and a data transmission delay. The VoIP utilizes a Real-time Transport Protocol (RTP) to support the timely arrival of packets. It is necessary to consider an IP network's features for the implementation of the RTP in the VoIP. In particular, real-time and interactive features of the voice are key factors in determining sound quality in typical telephone communications and, therefore, must be considered in designing the RTP in VoIP-based telephone communications. For example, a variety of techniques, such as a multi-frame technique, a Voice Activity Detection (VAD) function, and dynamic jitter buffering, have been developed in the field of a VoIP terminal to supplement the above-mentioned IP network's features. However, the RTP processing in the terminal has a limitation in supplementing the delay and loss in the IP network. In particular, there is a trade-off between the schemes for supplementing real-time, interactive, and sound quality features. In order to overcome this, it is necessary to utilize a variety of packet processing schemes.

Since Virtual Private Networks(VPNs) are widely utilized, there is an increasing need to apply the VoIP to the VPN that is capable of securing the same security as a private network using a public network.

However, the application of the VoIP to the VPN has the following drawbacks.

First, a processing time increases upon encoding and decoding for application of a VPN encryption scheme, causing a packet delay and deteriorating the real-time feature.

For example, when an RTP voice packet is coded using a G.723.1 (6.3 kbps) scheme in the VoIP, it is necessary to transmit 24-byte packet data per 30 msec and when the RTP voice packet is coded using a G.729 (8 kbps) scheme, it is necessary to transmit 10-byte packet data per 10 msec. For a VPN-based VoIP, such voice data to be transmitted and received must be encrypted and decrypted.

When the VoIP is applied to the VPN, a packet processing time increases due to the encryption and decryption of the packet data that is periodically transmitted as described above, which acts as an obstacle to the real-time feature and affects the sound quality in telephone communications.

Second, the utilization of Internet Protocol Security (IPSec), which is a basic packet processing scheme in the VPN, increases the use of bandwidth due to the presence of packet overhead.

An increased bandwidth is needed for voice codec in a VPN.

Comparing bandwidths when an RTP voice packet is coded using a G.729A scheme in a network with VPN and a network without VPN, the use of bandwidth when VAD is on 60% of that when the VAD is off.

Comparing bandwidths when an RTP voice packet is coded using a G.729A scheme in a network with VPN and a network without VPN using IPv4 or IPv6, it can be seen that the network with VPN needs a larger bandwidth than that of the network without VPN.

In particular, IPv6 has an IP header of 40 byte, which is larger than the 20 byte header of IPv4, and thus IPv6 wastes a relatively large bandwidth over IPv4 when VPN is used. This is because the bandwidth is wasted in both an original header and a new header in a tunnel mode as the size of the IP header increases, and thus more waste is generated in IPv6.

As stated above, the application of the VoIP to the VPN increases a bandwidth needed for coding, resulting in communication quality deterioration and transfer time delay.

### SUMMARY OF THE INVENTION

The present invention has been made to solve the aforementioned problems. It is an object of the present invention to provide a method and apparatus to process voice data in which a bandwidth is efficiently used in an environment using a public IP network (e.g., VPN or the like).

It is another object of the present invention to provide a method and apparatus to process voice data that is capable of enhancing communication quality by reducing delay factors of RTP packets.

It is yet another object of the present invention to provide a method and apparatus to process voice data that is capable of enhancing VoIP system performance by selectively processing VPN-based voice packets.

In an embodiment of the present invention, a method is provided comprising: encrypting a call connection packet and transmitting the encrypted call connection packet from a terminal at a transmitting side to a terminal at a receiving side; encrypting a call connection response packet responsive to the call connection packet and transmitting the encrypted response packet from the terminal at the receiving side to the terminal at the transmitting side to establish a communication path between the terminal at the transmitting side and the terminal at the receiving side; and transmitting non-encrypted voice media data from the terminal at the transmitting side to the terminal at the receiving side via the communication path.

The voice media data preferably comprises real-time transport protocol data.

In another embodiment of the present invention, a method is provided comprising: confirming a destination address of a call connection packet with a terminal at a transmitting side; storing call connection information within the call connection packet and registering the call connection information with an address translation table upon the destination address being directed to a private network; encrypting the call connection packet and transmitting the encrypted call connection packet from the terminal at the transmitting side to a terminal at a receiving side; storing the call connection information within the call connection packet therein with the terminal at the receiving side receiving the call connection packet; encrypting a call connection response packet responsive to the call connection packet and transmitting the encrypted response packet from the terminal at the receiving side to the terminal at the transmitting side to establish a communication path between the terminal at the transmitting side and the terminal at the receiving side; and transmitting non-encrypted voice media data using the call connection information via the communication path between the terminal at the transmitting side and the terminal at the receiving side.

The call connection information preferably comprises a real-time transport protocol in the call connection packet.

The call connection information preferably comprises a Voice over Internet Protocol (VoIP) signaling message.

In still another embodiment of the present invention, an apparatus is provided comprising: an address translation table adapted to store address translation information to enable several hosts in a local network to simultaneously communicate with a global network; a routing table adapted to store routing information therein; an input unit adapted to receive voice media data over an Internet Protocol (IP) network and to determine whether or not the voice media data is virtual private network based; a parsing unit adapted to parse the voice media data to detect real-time transport protocol information of the voice media data upon a determination by the input unit that the voice media data is virtual private network based and to register the detected real-time transport protocol information with the address translation table; a packet processing unit adapted to translate the voice media data into a virtual private network packet; and a routing unit adapted to rout the voice media data input via the input unit in accordance with the information stored in the address translation table and the routing table.

The address translation table preferably comprises a network address port translation table.

The input unit is preferably adapted to determine whether the voice media data is virtual private network based in accordance with a destination address of the input voice media data.

The real-time transport protocol information detected by the parsing unit preferably comprises media gateway interface real-time transport protocol port information.

The packet processing unit is preferably adapted to encapsulate the voice packet to translate it to the virtual private network packet and to perform packet-shaping of the virtual private network-based voice packet.

The routing unit is preferably adapted to route a virtual private network-based voice packet in accordance with the real-time transport protocol information stored in the address translation table after a communication path for the virtual private network-based voice packet has been established.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIGS. 1A, 1B, 2A and 2B indicate an increased bandwidth needed for voice codec in a virtual private network;

FIG. 3 is a block diagram of an apparatus for processing voice data in a virtual private network according to an exemplary embodiment of the present invention;

FIG. 4 is a flowchart of a method of processing voice data in a virtual private network according to an exemplary embodiment of the present invention; and

FIG. 5 is a view of a procedure of processing voice data in transmitting and receiving sides according to an exemplary embodiment of the present invention.

### DETAILED DESCRIPTION OF THE INVENTION

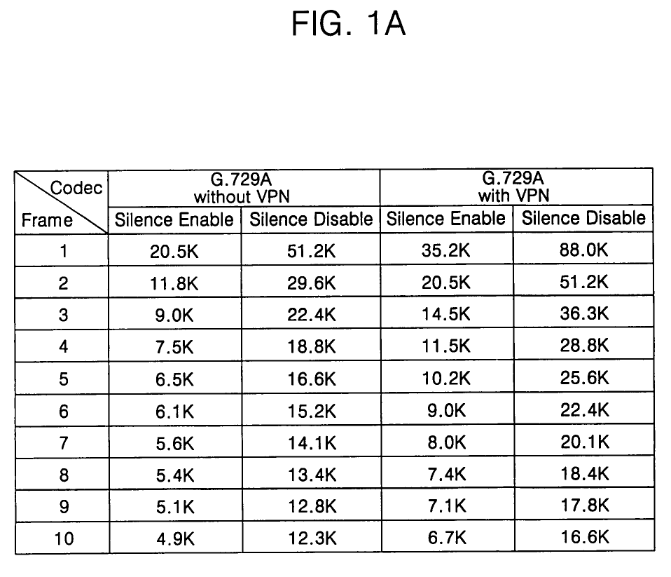

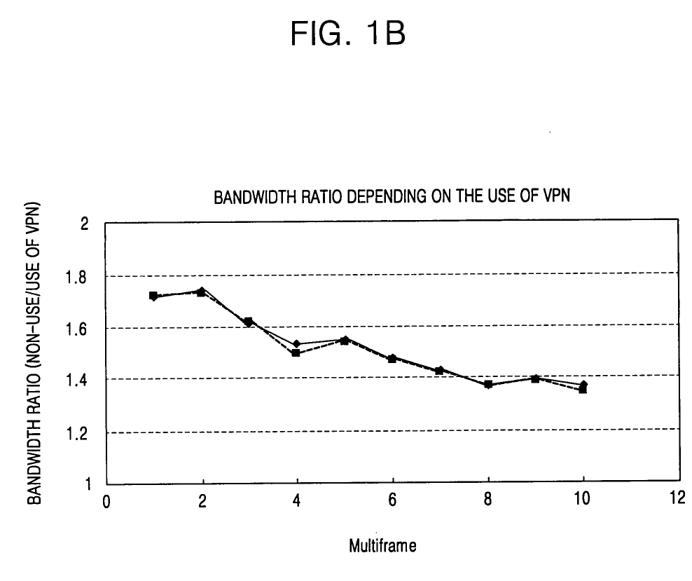

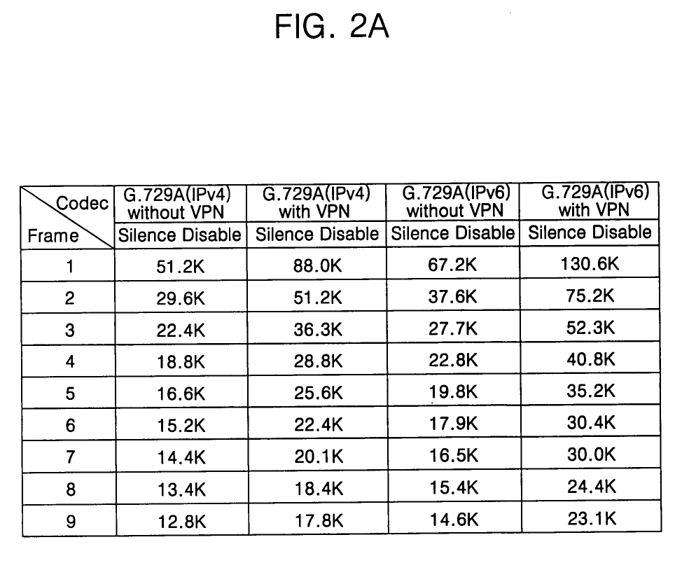

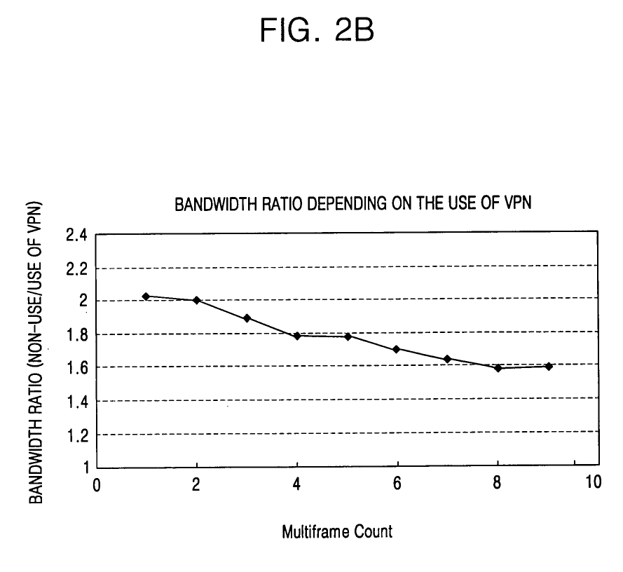

FIGS. 1A, 1B, 2A and 2B indicate an increased bandwidth needed for voice codec in a VPN.

FIG. 1A is a comparison table indicating bandwidths when an RTP voice packet is coded using a G.729A scheme in a network with VPN and a network without VPN. In the table of FIG. 1A, the use of bandwidth when VAD is 60% of that when the VAD is off. FIG. 1B is a view of a bandwidth ratio depending on the use of VPN with reference to FIG. 1A.

FIG. 2A is a comparison table indicating bandwidths when an RTP voice packet is coded using a G.729A scheme in a network with VPN and a network without VPN using IPv4 or IPv6. FIG. 2B is a view of a bandwidth ratio depending on VPN use with reference to FIG. 2A.

Referring to FIGS. 1A, 1B, 2A and 2B, it can be seen that the network with VPN needs a larger bandwidth than that of the network without VPN.

In particular, referring to FIG. 2A, IPv6 has an IP header of 40 byte, which is larger than the 20 byte header of IPv4, and thus IPv6 wastes a relatively large bandwidth over IPv4 when VPN is used. This is because the bandwidth is wasted in both an original header and a new header in a tunnel mode as the size of the IP header increases, and thus more waste is generated in IPv6.

As stated above, referring to FIGS. 1B, 2A and 2B, the application of the VoIP to the VPN increases a bandwidth needed for coding, resulting in communication quality deterioration and transfer time delay.

Hereinafter, the configuration and operation of embodiments of the present invention will be described in more detail with reference to the accompanying drawings.

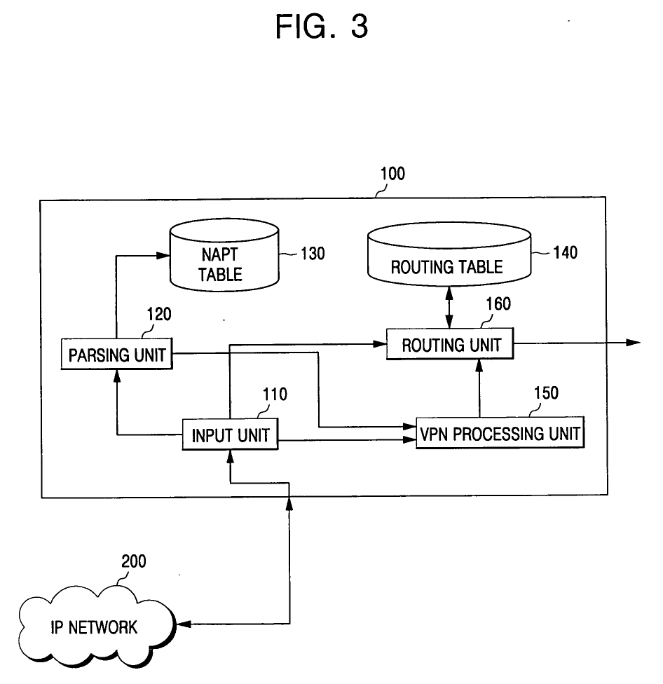

FIG. 3 is a block diagram of an apparatus for processing voice data in a VPN according to an exemplary embodiment of the present invention.

Referring to FIG. 3, a voice data processor 100 according to an exemplary embodiment of the present invention includes an input unit 110, a parsing unit 120, a Network Address Port Translation (NAPT) table 130, a routing table 140, a VPN processing unit 150, and a routing unit 160.

The input unit 110 receives a voice packet over an IP network 200 and determines whether or not the voice packet is VPN-based. That is, the input unit 110 checks a destination address of the voice packet to determine whether or not the destination address is for VPN. The input unit 100 also sends the result to the parsing unit 120.

When the voice packet is VPN-based, the parsing unit 120 parses the voice packet to detect its RTP information (e.g., RTP port information or the like) and registers the RTP information with the NAPT table 130.

The NAPT table 130 stores information needed to perform the NAPT. The NAPT refers to network address translation for allowing several hosts in a local network to share an IP address for simultaneous communication with a global network.

The routing table 140 stores information needed for routing packet data between networks or in the networks.

The VPN processing unit 150 translates the voice packet, which is input via the input unit 10, to a VPN packet and delivers the translated VPN packet to the routing unit 160. In other words, the VPN processing unit 150 encapsulates the input voice packet into the VPN packet and then sends the VPN packet to the routing unit 160.

The routing unit 160 confirms a destination address of the VPN packet that is received from the VPN processing unit 150 and then routes the VPN packet to a relevant destination. In particular, the routing unit 160 routes the VPN packet based on the routing table 140 before a communication path for the VPN-based voice packet has been established while the routing unit 160 routes the VPN packet based on the RTP information stored in the NAPT table 130 after the communication path for the VPN-based voice packet has been established.

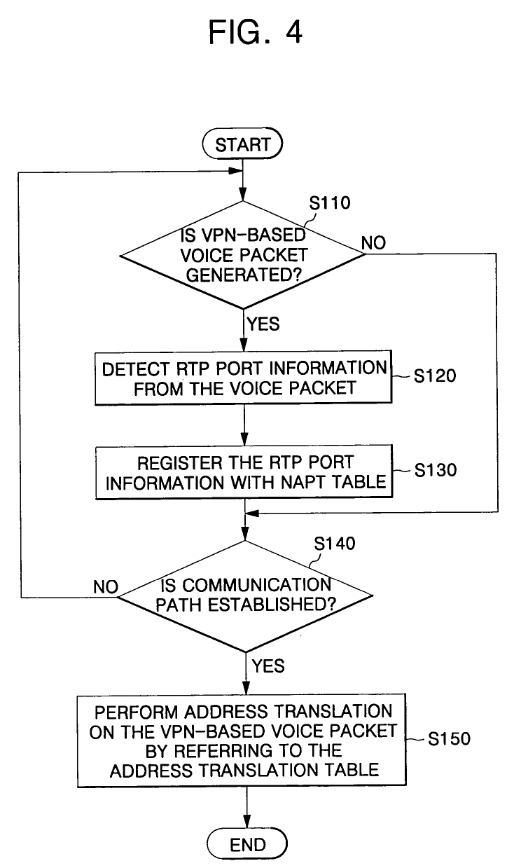

FIG. 4 is a flowchart of a method of processing voice data in a VPN according to an exemplary embodiment of the present invention. Referring to FIG. 4, when a VPN-based voice packet is generated in a data server for VoIP processing (S110), the data server detects RTP information from the voice packet (S120) and then registers the RTP information with an address translation table (e.g., an NAPT table or the like) (S130). In other words, when a voice packet to be transmitted to the exterior is generated in the data server or the data server receives a voice packet, the data server detects the RTP port information from the voice packet and then registers the RTP port information with the address translation table.

This is intended to route VPN-based voice packets, which are subsequently generated, using the RTP port information registered with the address translation table.

After registering the RTP port information of a relevant voice packet with the address translation table as described above, the data server confirms whether a communication path has been established between transmitting and receiving sides of the voice packet. When the communication path has been established (S140), the data server performs address translation on the VPN-based voice packet by referring to the address translation table (S150). That is, the data server performs address translation using the address translation information (e.g., the RTP port information or the like) registered with the address translation table without performing the VPN encapsulation through packet shaping on the voice packet that is generated after the communication path has been established. Thereafter, the transmitting side and the receiving side transmit and/or receive the voice packets therebetween.

Thus, it is possible to effect a VPN connection without transmission delay and bandwidth waste between two terminals using the VPN, by not VPN-encapsulating the VPN-based voice packets. That is, it is possible to reduce the transmission delay and bandwidth waste pf the relevant-packet by not performing the VPN encapsulation with respect to each packet generated when the transfer packet is coded in the VPN.

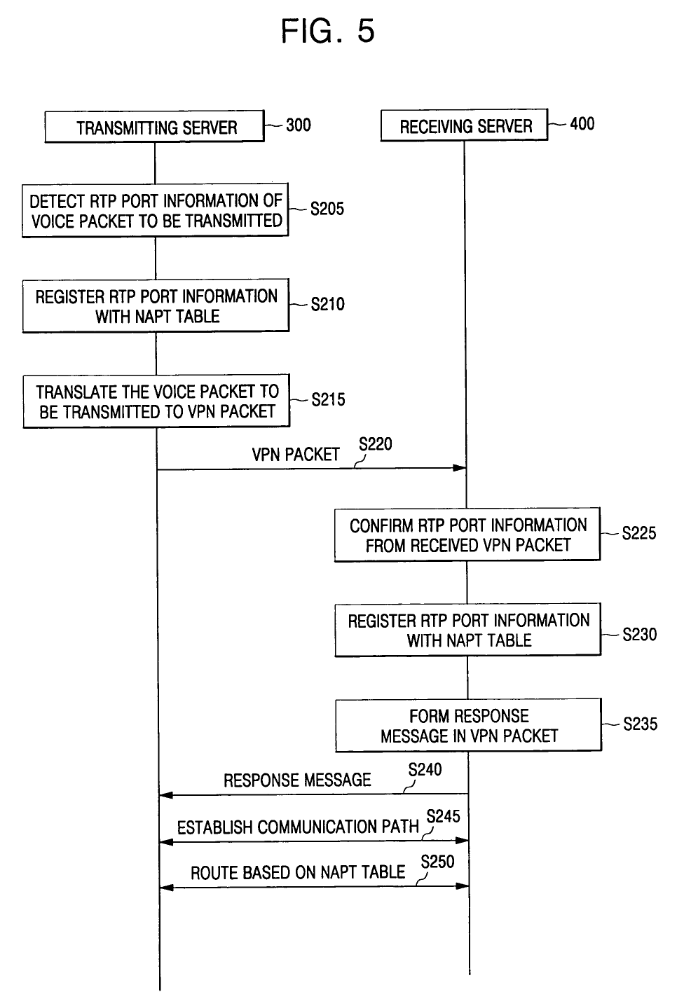

FIG. 5 is a view a procedure of processing voice data in a transmitting side and a receiving side according to an exemplary embodiment of the present invention. Referring to FIG. 5, the transmitting server 300, which desires to transmit a VPN-based voice packet, detects RTP port information (e.g., Media Gateway Interface (MGI) RTP port information, or the like) of the voice packet (S205) and then registers the RTP port information with the NAPT table (S210). This is intended for the transmitting server 300 to refer to the registered information when routing the VPN-based voice packet after the communication path has been established. The transmitting server 300 also translates the voice packet to a VPN packet (S215) and then sends the VPN packet to the receiving server 400 (S220). That is, the transmitting server 300 performs VPN encapsulation on the voice packet to translate it to the VPN packet and sends the VPN packet to the receiving server 400.

Then, the receiving server 400 confirms the RTP port information from the received VPN packet (S225) and registers the RTP port information with the NAPT table (S230). The receiving server 400 confirms the RTP port information by packet-shaping the received VPN packet. The receiving server 400 forms a response message into a VPN packet in response to receiving the VPN packet (S235) and sends the response message to the transmitting server 300 (S240).

When the communication path has been established between the transmitting server 300 and the receiving server 400 by the process described above, the transmitting server 300 and the receiving server 400 route subsequently generated voice packets by referring to the information registered with the NAPT table (S250). In other words, when a voice packet to be transmitted or received is generated after the communication path has been established between the transmitting server 300 and the receiving server 400, the transmitting server 300 and the receiving server 400 route the generated voice packet using the RTP port information registered with the NAPT table in the processes S210 and S230 without VPN-encapsulating the voice packet.

More specifically, in the foregoing example, the apparatus and process have been described in which the RTP port information is detected from the relevant voice packet and is registered with the NAPT table so that routing is possible without translating the VPN-based voice packet to the VPN packet. However, the present invention is not limited to registering the RTP port information of the voice packet with the NAPT table. That is, the present invention covers all processes of detecting address information needed for the VPN-based voice packet routing with the RTP from the voice packet and performing routing using the routing information.

As can be seen from the foregoing, according to the present invention, it is possible to effect a VPN connection without transmission delay and bandwidth waste between two terminals using the VPN, by not performing VPN-encapsulation of the VPN-based voice packets. That is, it is possible to reduce the transmission delay and bandwidth waste of the relevant-packet by omitting the VPN encapsulation process with respect to each packet generated when the transfer packet is coded in the VPN.

The forgoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method comprising:
encrypting a call connection packet and transmitting the encrypted call connection packet from a terminal at a transmitting side to a terminal at a receiving side;
encrypting a call connection response packet responsive to the call connection packet and transmitting the encrypted response packet from the terminal at the receiving side to the terminal at the transmitting side to establish a communication path between the terminal at the transmitting side and the terminal at the receiving side; and
transmitting non-encrypted voice media data from the terminal at the transmitting side to the terminal at the receiving side via the communication path.

2. The method according to claim 1, wherein the voice media data comprises real-time transport protocol data.

3. A method comprising:
confirming a destination address of a call connection packet with a terminal at a transmitting side;
storing call connection information within the call connection packet and registering the call connection information with an address translation table upon the destination address being directed to a private network;
encrypting the call connection packet and transmitting the encrypted call connection packet from the terminal at the transmitting side to a terminal at a receiving side;
storing the call connection information within the call connection packet therein with the terminal at the receiving side receiving the call connection packet;
encrypting a call connection response packet responsive to the call connection packet and transmitting the encrypted response packet from the terminal at the receiving side to the terminal at the transmitting side to establish a communication path between the terminal at the transmitting side and the terminal at the receiving side; and
transmitting non-encrypted voice media data using the call connection information via the communication path between the terminal at the transmitting side and the terminal at the receiving side.

4. The method according to claim 3, wherein the call connection information comprises a real-time transport protocol in the call connection packet.

5. The method according to claim 3, wherein the call connection information comprises a Voice over Internet Protocol (VoIP) signaling message.

6. An apparatus comprising:
an address translation table adapted to store address translation information to enable several hosts in a local network to simultaneously communicate with a global network;
a routing table adapted to store routing information therein;
an input unit adapted to receive voice media data over an Internet Protocol (IP) network and to determine whether or not the voice media data is virtual private network based;
a parsing unit adapted to parse the voice media data to detect real-time transport protocol information of the voice media data upon a determination by the input unit that the voice media data is virtual private network based and to register the detected real-time transport protocol information with the address translation table;
a packet processing unit adapted to translate the voice media data into a virtual private network packet; and
a routing unit adapted to rout the voice media data input via the input unit in accordance with the information stored in the address translation table and the routing table.

7. The apparatus according to claim 6, wherein the address translation table comprises a network address port translation table.

8. The apparatus according to claim 6, wherein the input unit is adapted to determine whether the voice media data is virtual private network based in accordance with a destination address of the input voice media data.

9. The apparatus according to claim 6, wherein the real-time transport protocol information detected by the parsing unit comprises media gateway interface real-time transport protocol port information.

10. The apparatus according to claim 6, wherein the packet processing unit is adapted to encapsulate the voice packet to translate it to the virtual private network packet and to perform packet-shaping of the virtual private network-based voice packet.

11. The apparatus according to claim 6, wherein the routing unit is adapted to route a virtual private network-based voice packet in accordance with the real-time transport protocol information stored in the address translation table after a communication path for the virtual private network-based voice packet has been established.
